(19) United States
(12) Patent Application Publication
(10) Pub. No.: US 2006/0014876 A1
(43) Pub. Date: Jan. 19, 2006

(54) Thermally conductive liquid crystalline polymer compositions and articles formed therefrom

(75) Inventors: Corinne Bushelman, Alpharetta, GA (US); Christie Crowe, Alpharetta, GA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Solvay Advanced Polymers, LLC

(21) Appl. No.: 10/526,231

(22) PCT Filed: Sep. 3, 2003
(86) PCT No.: PCT/US03/27250

§ 371 Date: Jul. 29, 2005

Related U.S. Application Data
(60) Provisional application No. 60/407,309, filed on Sep. 3, 2002.

(51) Int. Cl. C08K 3/08

(52) U.S. Cl. 524/439

(57) ABSTRACT

This invention relates to thermally conductive liquid crystalline polymer compositions. The composition is comprised of a liquid crystalline polymer and metal particles. At least about 90% by weight of the metal particles have an average particle size larger than 200 μm. In other embodiments of the invention, the average particle size of the metal particles is larger than 420 μm. Aluminum flakes are exemplary metal particles for use in this invention. The thermally conductive liquid crystalline polymer composition is useful for the manufacture of cookware and has sufficient thermal conductivity to provide browning during cooking. The composition is useful for the manufacture of oven cookware such as cooking pans, sheets, trays, dishes, casseroles, and the like.

### CROSS REFERENCE TO PROVISIONAL APPLICATIONS

This application claims priority from U.S. provisional patent application Ser. No. 60/407;309; filed Sep. 3, 2002, the entire disclosure of which is incorporated herein by reference.

### TECHNICAL FIELD

This invention is directed to liquid crystalline polymer compositions comprising metal particles and articles formed from the polymer composition, including cookware.

### BACKGROUND OF THE INVENTION

Metallic oven cookware, such as aluminum pans, are widely used when a browning and/or crisping effect is desirable. Because of the good thermal conductivity of metals, the heat is transferred to the food and the temperature at the surface of the aliment can reach the critical temperature required for browning. The drawback of metallic materials is their poor release properties. Consequently, either the application of butter/grease or surface treatment with a non-stick coating are required. In the bakery industry, this is a serious inconvenience since either solution increases production cost. Non-stick coatings are not durable and metallic cookware needs to be frequently recoated or replaced. Surface oxidation might also be a cause of problems.

On the other hand, cookware products made from high temperature polymeric materials do not oxidize. Moreover, because the surface of this class of polymers is generally chemically inert, the release properties are enhanced and the application of a non-stick coating is not necessary. Furthermore, high temperature thermoplastics offer a better weight/toughness ratio than metallic cookware. However, the thermal conductivity of polymers is insufficient to obtain the browning and/or crisping effect.

Liquid crystalline polymers (LCP) have been used to make cookware. Liquid crystalline polymers are generally divided into two groups depending upon whether they exhibit liquid crystalline or anisotropic order in solution (lyotropic) or in the melt phase (thermotropic). Thermotropic LCPs have been described by such terms as “liquid crystalline,” “liquid crystal,” or “anisotropic”. Thermotropic LCPs include, but are not limited to, wholly aromatic polyesters, aromatic-aliphatic polyesters, aromatic polyazomethines, aromatic polyester-carbonates and partly or wholly aromatic polyester-amides. Typically, LCPs are prepared from long and flat monomers which are fairly rigid along their molecular axes. These polymers also tend to have coaxial or parallel chain-extending linkages therebetween. To be considered wholly aromatic, each monomer of an LCP must contribute at least one aromatic ring to the polymeric backbone.

A liquid crystal polyester orients the molecular chain in the direction of flow under flow shear stress. Liquid crystal polyesters have excellent melt flowability and generally have a heat resistant deformation property of 300° C. or higher depending on their structure.

Commercially available liquid crystal polyesters possess many desirable properties. XYDAR® SRT-300, available from Solvay Advanced Polymers, LLC, for example, possesses a heat deflection temperature of about 355° C. under a flexural load of about 264 psi. LCPs are generally inflammable and radiation resistant. They generate very little smoke and do not drip when exposed to live flame. LCP can serve as an excellent electrical insulator with high dielectric strength and outstanding arc resistance. LCPs resist chemical attack from most polar and nonpolar solvents, including but not limited to: hot water, acetic acid, other acids, methyl ethyl ketone, isopropyl alcohol, trichloroethylene, caustics, bleaches and detergents, and hydrocarbons. LCPs generally have very low coefficients of friction and retain substantially high strength levels at relatively high temperatures.

With such excellent strength, lubricity, chemical resistance and other properties for temperatures ranging from below zero to melting points above 400° C., LCPs should be useful for a wide range of applications, including engine fuel system parts, engine bearings, and brackets, fasteners or housings for the automotive and/or aerospace industries; sockets, chip carriers, high temperature connectors, and/or switches for the electronics industry, in addition to cookware.

U.S. Pat. No. 5,529,716 discloses a liquid crystal polyester composition comprising a liquid crystal polyester, aluminum powders, flakes, or fibers, and optionally titanium oxide and/or talc for forming a lamp reflector.

### SUMMARY OF THE INVENTION

There exists a need in the food baking arts for polymeric oven cookware art that is capable of withstanding typical baking temperatures. There exists a need in the food baking arts for non-oxidizing bakeware that is capable of browning and crisping baked foods. There exists a need in the food baking arts for oven bakeware that does not require the application of non-stick coatings. There exists a need in the food baking arts for a cost-effective thermally conductive polymer composition for the manufacture of oven cookware.

These and other needs are met by certain embodiments of the present invention, that, provide a polymer composition comprising a liquid crystalline polymer and metal particles having a particle size, wherein the particle size of at least 90 weight % of the metal particles is greater than about 200 μm.

The earlier stated needs are also met by certain embodiments of the present invention, that provide a polymer composition comprising a liquid crystalline polymer and metal particles having an average particle size, wherein the average particle size is greater than about 420 μm.

The earlier stated needs are also met by certain embodiments of the present invention that provide melt fabricated, injection molded, and extruded articles formed from a polymer composition comprising a liquid crystalline polymer and metal particles having a particle size, wherein the particle size of at least 90 weight % of the metal particles is greater than about 200 μm.

The earlier stated needs are also met by certain embodiments of the present invention that provide melt fabricated, injection molded, and extruded articles formed from a polymer composition comprising a liquid crystalline polymer and metal particles having an average particle size, wherein the average particle size is greater than about 420 μm.

Furthermore, the earlier stated needs are met by certain embodiments of the present invention that provide cookware, including pans, sheets, trays, dishes, and casseroles formed from a polymer composition comprising a liquid crystalline polymer and metal particles having a particle size, wherein the particle size of at least 90 weight % of the metal particles is greater than about 200 μm.

The earlier stated needs are further met by certain embodiments of the present invention that provide cookware, including pans, sheets, trays, dishes, and casseroles formed from a polymer composition comprising a liquid crystalline polymer and metal particles having an average particle size, wherein the average particle size is greater than about 420 μm.

Furthermore, the earlier stated needs are met by certain embodiments of the present invention that provide a method of increasing thermal conductivity of an article formed from a polymer composition comprising compounding metal particles, wherein the particle size of at least 90 weight % of the metal particles is greater than about 200 μm, with a liquid crystalline polymer and forming the article from the polymer composition.

The earlier stated needs are further met by certain embodiments of the present invention that provide a method of increasing thermal conductivity of an article formed from a polymer composition comprising compounding metal particles having an average particle size, wherein the average particle size of the metal particles is greater than about 420 μm, with a liquid crystalline polymer and forming the article from the polymer composition In addition, the earlier stated needs are met by certain embodiments of the present invention that provide a use of metal particles, wherein at least 90 weight % of the metal particles have a particle size greater than about 200 μm, as an additive of a liquid crystalline polymer composition to increase the conductivity of the polymer composition.

Furthermore, the earlier stated needs are met by certain embodiments of the present invention that provide a use of metal particles having an average particle size, wherein the metal particles have an average particle size greater than about 420 μm, as an additive of a liquid crystalline polymer composition to increase the conductivity of the polymer composition.

The present invention provides a new polymer composition that allows heat to evenly transfer through the polymeric cookware and into the food. The introduction of metal fillers improves heat transfer through the filled material. However, the utilization of thermally conductive polymeric materials is very limited due to their extremely high cost. Indeed, thermally conductive fillers are typically very expensive. Moreover, high filler loadings are required to improve the thermal conductivity. Indeed, at low filler volume fraction, the thermal conductivity of the composite is close to the thermal conductivity of the matrix. The thermal conductivity is improved only when the critical loading is reached.

The present invention also provides a cost effective thermally conductive polymer composition for the manufacture of oven cookware. The present invention addresses the longstanding limitation of insufficient browning and crisping of foods baked in polymeric cookware.

Additional advantages and aspects of the present invention will become readily apparent to those skilled in the art from the following detailed description, wherein embodiments of the present invention are shown and described, by way of illustration of the best mode contemplated for practicing the present invention. As will be described, the present invention is capable of other and different embodiments, and its several details are susceptible to modification in various obvious respects, all without departing from the spirit of the present invention. Accordingly, the description is to be regarded as illustrative in nature, and not as limitative.

### BRIEF DESCRIPTION OF THE DRAWINGS

FIG. 1 illustrates a baking sheet according to an embodiment of the invention.

FIG. 2. illustrates a multi-loaf bread pan according to an embodiment of the invention.

FIG. 3 is a graph contrasting the surface temperature of bread baked in a bread pan according to an embodiment of the invention versus the surface temperature of bread baked in a prior art bread pan.

### DETAILED DESCRIPTION OF THE INVENTION

The present invention addresses the deficiencies of prior art cookware. The present invention provides cost-effective polymeric cookware that is capable of browning and crisping foods. The present invention provides non-sticking cookware that does not require the application of a non-stick coating. These improvements have been accomplished by the incorporation of large metal particles in a liquid crystalline polymer composition. In certain embodiments of the present invention, at least about 90% by weight of the metal particles have a particle size of at least about 200 μm. In other embodiments of the present invention, at least about 90% by weight of the metal particles have a particle size of at least about 400 μm. Further, in other embodiments of the present invention, at least about 90% by weight of the metal particles have a particle size of at least about 500 μm. In certain other embodiments of the present invention, the metal particles have an average particle size greater than about 420 μm. Furthermore, in certain other embodiments of the present invention, the metal particles have an average particle size greater than about 500 μm

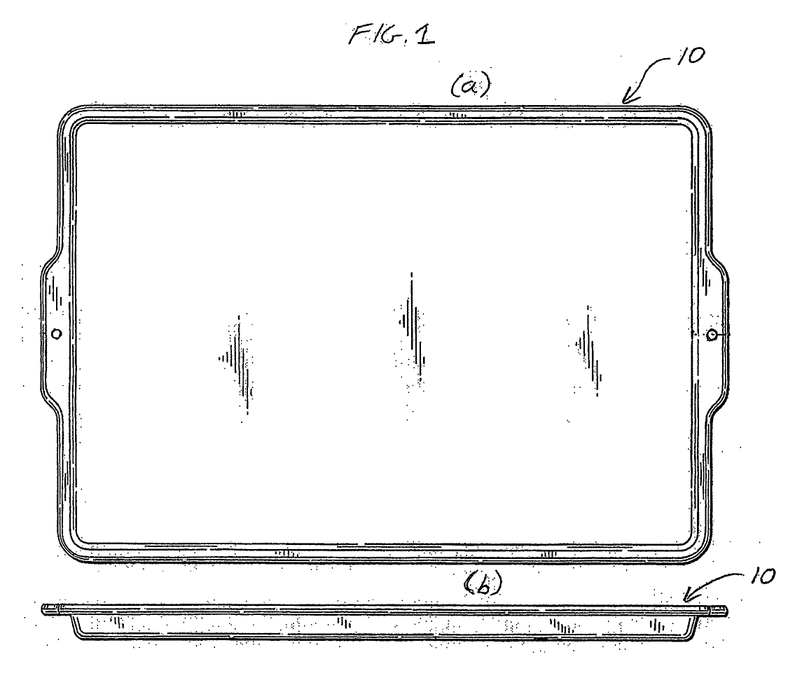

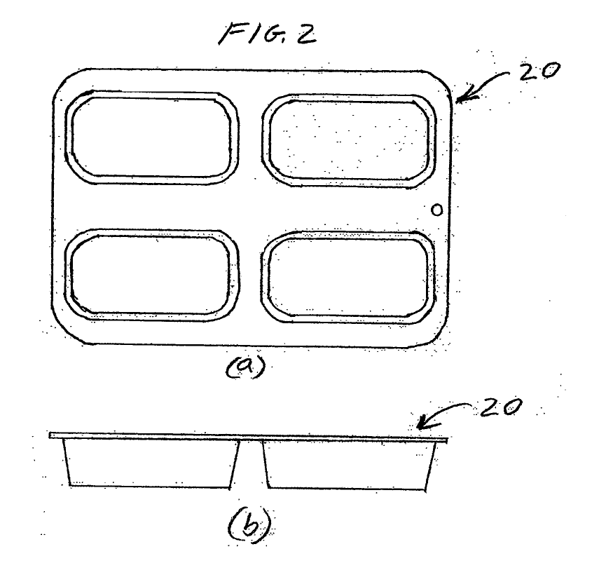

A liquid crystalline polymer composition that has sufficient thermal conductivity to provide browning during cooking has been discovered. This new polymer composition is useful for the manufacture of oven cookware such as cooking pans, sheets, trays, dishes, casseroles, and the like. In certain embodiments of the present invention, the sheets include baking sheets 10, as illustrated in FIG. 1. In other certain embodiments of the present invention, the pans include multi-loaf bread pans 20, as illustrated in FIG. 2.

It has been discovered that the use of large particle size metal particles in a liquid crystalline polymer composition used to form cookware provides sufficient thermal conductivity to allow browning and crisping of food. Metal particles suitable for use in this invention include the following: aluminum, brass, copper, magnesium, nickel, stainless steel, steel, silver, tin, and zinc particles.

The use of large particle size metal particles, such as aluminum flake with an average particle size greater than about 420 μm, provide increased thermal conductivity to articles formed from LCP polymer compositions. The increased thermal conductivity allows cookware formed from LCP polymer compositions comprising large particle size metal particles to brown and crisp foods cooked therein. It is believed that articles formed from polymer compositions comprising metal particles, including aluminum flake, wherein at least about 90% by weight of the metal particles have a particle size of at least about 200 μm would also provide the necessary thermal conductivity to allow for browning and crisping of food.

In certain embodiments of the present invention the polymer composition comprises from about 20 weight % to about 70 weight % of metal particles based on the total weight of the polymer composition. In certain other embodiments, the polymer composition comprises from about 30 weight % to about 60 weight % of metal particles based on the total weight of the polymer composition. A metal particle concentration of about 45 weight % is well-suited for use in certain embodiments of the present invention.

In certain embodiments of the present invention, at least 90 weight % of the metal particles have a particle size greater than about 200 μm. The particle size can be determined by the use of sieves. If less than 10% of a metal particle sample passes through a 200 μm sieve, then at least 90 weight % of the metal particles have a particle size greater than about 200 μm. In certain embodiments of the present invention, at least 90 weight % of the metal particles have a particle size greater than about 400 μm. Thus, less than 10 weight % of the metal particles pass through a 400 μm sieve. In certain other embodiments of the present invention, at least 90 weight % of the metal particles have a particle size greater than about 500 μm. Thus, less than 10 weight % of the metal particles pass through a 500 μm sieve.

The average particle size of the metal particles is greater than about 420 μm in certain embodiments of the present invention. In certain other embodiments, the average particle size is greater than about 500 μm. Average particle size of the metal particles can be determined by conventional methods, including ultrasound measurement techniques, laser diffraction techniques, and physical measurement techniques. Laser diffraction techniques are well-suited for measuring metal particle sizes. Laser diffraction particle size analyzers are commercially available from Microtrac and Beckman Coulter, Inc.

Aluminum particles, particularly aluminum flakes and fibers, are well-suited for use as the metal particles in polymer compositions of the present invention. Aluminum has high thermal conductivity. In addition, the use of aluminum particles is relatively cost effective compared to the use of other thermally conductive metal particles. The use of larger-sized aluminum flakes and fibers provides an added benefit over the use of smaller particle-sized powders. In powder form, many metals, such as aluminum, are combustible in air and present a fire and explosion hazard. Aluminum having a particle size larger than about 200 μm do not support combustion as do smaller particle size aluminum powder. Aluminum having a particle size greater than 500 μm, such as aluminum flake, do not normally sustain combustion, consequently its storage and handling is facilitated compared to smaller particle size aluminum powders. Suitable aluminum fibers for use in certain embodiments of the present invention can be fibrous metallic aluminum, which can be produced by a high frequency vibration method or by cutting aluminum wires.

In certain embodiments of the present invention, the polymer composition comprises an aluminum flake with an average length from about 0.25 mm to about 10 mm, an average width from about 0.25 mm to about 10 mm, and an average thickness from about 5 μm to about 250 μm. In certain other embodiments of the present invention, the average length of the aluminum flake is from about 0.5 mm to about 5 mm, the average width of the aluminum flake is from about 0.5 mm to about 5 mm, and the average thickness of the aluminum flake is from about 10 μm to about 100 μm. In certain particular embodiments of the present invention, the average length of the aluminum flake is about 0.6 mm, the average width of the aluminum flake is about 0.6 mm, and the average thickness of the aluminum flake is about 25 μm. In other particular embodiments of the present invention, the average length of the aluminum flake is about 2.0 mm, the average width of the aluminum flake is about 0.5 mm, and the average thickness of the aluminum flake is about 25 μm. In addition, the average length of the aluminum flake is about 1.0 mm, the average width of the aluminum flake is about 1.0 mm, and the average thickness of the aluminum flake is about 25 μm, in other embodiments of the present invention.

Metal particles with a large length to thickness aspect ratio are suitable for use in certain embodiments of the present invention. Metal particles with length to thickness aspect ratios of greater than about 20:1. In certain embodiments of the present invention the length to thickness aspect ratio is from about 20:1 to about 80:1.

Suitable aluminum flakes for use in this invention are available from Transmet Corporation and include Transmet Corporation K-102 (1 mm×1 mm×25 μm). In certain other embodiments, Transmet Corporation K-107 (2 mm×0.5 mm×25 μm) and K-109 (0.6 mm×0.6 mm×25 μm) aluminum flakes can be used. Another suitable source of aluminum flakes for use in the present invention is Palko Aluminum, Inc.

LCP compositions comprising aluminum flake according to embodiments of the present invention can be formed into cookware with sufficient thermal conductance to effect browning or crisping of the ailments, without the addition of any other thermally conductive particles to the polymer composition. Cookware capable of browning and crisping food can be formed from polymer compositions that consist essentially of the liquid crystalline polymer, one type of metal particle, such as aluminum flake, and optional non-thermally conductive fillers, such as glass fibers and minerals. For example, the one type of metal particle can be Transmet Corporation K-102 aluminum flake.

Liquid crystalline polymers according to certain embodiments of the present invention have a Tₘ greater than 150° C. Preferably, liquid crystalline polymers according to certain embodiments of the present invention have a Tₘ greater than 250° C. The liquid crystalline polymers according to certain embodiments of the present invention are at least partially aromatic polyesters. In certain embodiments the LCPs are wholly aromatic polyesters.

The liquid crystalline polyesters used in certain embodiments of the present invention are formed from the reaction product of at least one dicarboxylic acid and at least one diol. In certain embodiments of the present invention, the polyesters are formed from the reaction product of at least one dicarboxylic acid, at least one diol, and at least one hydroxycarboxylic acid. Aromatic dicarboxylic acid, diols, and hydroxycarboxylic acids are suitable for forming liquid crystalline polyesters according to embodiments of the present invention. Suitable liquid crystal polyesters can be formed from the following structural units derived from either aromatic dicarboxylic acids, aromatic diols, or aromatic hydroxycarboxylic acids:

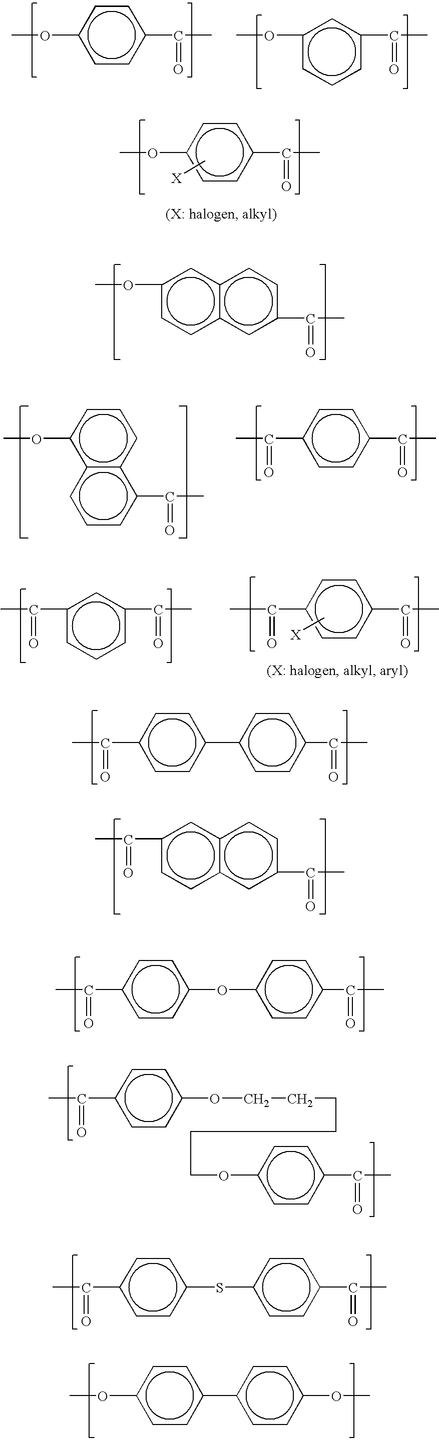

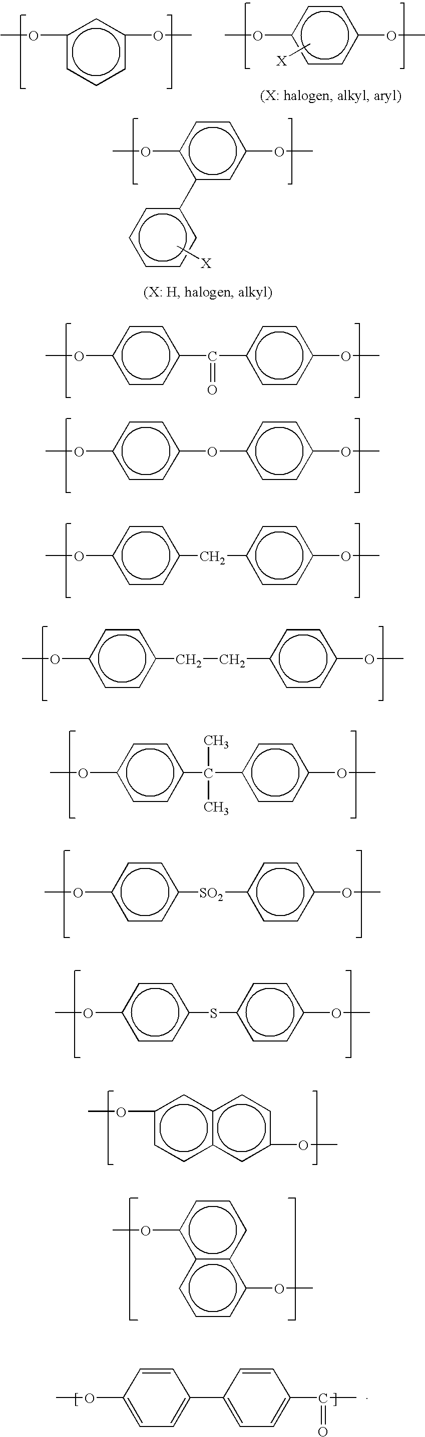

Of the above aromatic structural units, the following structural units are particularly well-suited for forming liquid crystalline polymer for use in polymer compositions according to the present invention:
hydroquinone structure (I) 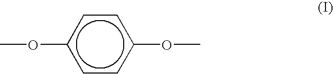
4,4′-biphenol structure (II) 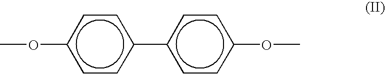
terephthalic acid structure (III) 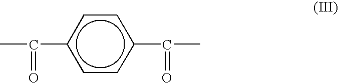
isophthalic acid structure (IV) 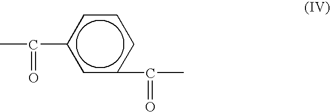
2,6-naphthalic dicarboxylic acid structure (V) 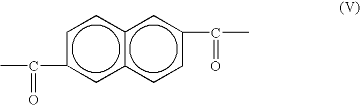
p-hydroxybenzoic acid structure (VI) 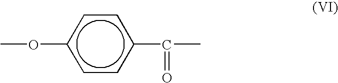
2,6-hydroxynaphthalic acid structure (VII)

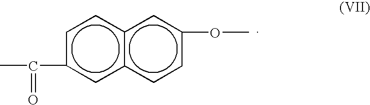

In certain embodiments of the present invention, the LCP is formed from at least one dicarboxylic acid selected from the group consisting of terephthalic acid, isophthalic acid, 2,6-naphthalic dicarboxylic acid, 3,6-naphthalic dicarboxylic acid, 1,5-naphthalic dicarboxylic acid, 2,5-naphthalic dicarboxylic acid, and at least one diol selected from the group consisting of hydroquinone, resorcinol, 4,4′-biphenol, 3,3′-biphenol, 2,4′-biphenol, 2,3′-biphenol, and 3,4′-biphenol. In certain other embodiments of the present invention, the LCP is further formed from hydroxycarboxylic acid monomers selected from the group consisting of p-hydroxybenzoic acid, m-hydroxybenzoic acid, 2,6-hydroxynaphthalic acid, 3,6-hydroxynaphthalic acid, 1,6-hydroxynaphthalic acid, and 2,5-hydroxynaphthalic acid.

In certain embodiments of the present invention, the LCP comprises up to about 50 mole % terephthalic acid structural units, up to about 30 mole % isophthalic acid structural units, and up to about 50 mole % biphenol structural units. In certain other embodiments of the present invention, the LCP comprises from about 5 mole % to about 30 mole % terephthalic acid structural units, up to about 20 mole % of isophthalic acid structural units, and from about 5 mole % to about 30 mole % biphenol structural units. In certain other embodiments of the present invention, the LCP further comprises from about 5 mole % to about 40 mole % hydroquinone structural units. About 5 mole % to about 35 mole % 2,6-naphthalic dicarboxylic acid structural units are additionally present in other embodiments of the present invention.

In certain embodiments of the present invention, the LCP further comprises from about 40 mole % to about 70 mole % of p-hydroxybenzoic acid structural units. The LCP according to certain other embodiments of the present invention further comprises from about 15 mole % to about 30 mole % of 2,6-hydroxynaphthalic acid.

The LCP used in certain embodiments of the present invention is formed by polymerizing a mixture of aromatic monomers consisting of terephthalic acid, isophthalic acid, p-hydroxybenzoic acid, and biphenol. In other certain embodiments of the present invention, the LCP is formed by polymerizing a mixture of aromatic monomers consisting of terephthalic acid, p-hydroxybenzoic acid, and biphenol. In other certain embodiments of the present invention, the LCP is formed by polymerizing a mixture of aromatic monomers consisting of terephthalic acid, p-hydroxybenzoic acid, biphenol, and hydroquinone. Other suitable LCPs for use in the embodiments of the present invention include those comprising hydroxy naphthalic acid, naphthalic dicarboxylic acid, hydroquinone, or resorcinol structural units.

Commercially available wholly aromatic liquid crystalline polyesters suitable for use in embodiments of the present invention include XYDAR® SRT-300, SRT-400, SRT-700, SRT-900, and SRT 1000 liquid crystalline polymers available from Solvay Advanced Polymers, LLC.

Polymer compositions according to certain embodiments of the present invention, may further comprise optional non-thermally conductive additives, including a reinforcing filler, such as glass fiber; minerals, such as talc and wollastonite; pigments; coupling agents; antioxidant; thermal stabilizer; ultraviolet light stabilizer; plasticizer; and processing aids, such as a lubricant; and mold release agent. Non-thermally conductive additives are those additives which have low thermal conductivity, unlike metals, which have high thermal conductivity. Non-thermally conductive materials are commonly known as thermal insulators.

Glass fibers are commercially available in continuous filament, chopped, and milled forms. Any of these forms of glass fiber can be used in the practice of this invention. A suitable glass fiber for embodiments of this invention is CERTAINTEED® 910 fiberglass, available from Vetrotex CertainTeed Corp. Other suitable glass fibers according to certain embodiments of the present invention are Owens Corning OCF 497EE and PPG 3790. A suitable talc for certain embodiments of the present invention is VERTAL® 1000, available from Luzenac. Other suitable sources of talc are X-50™ available from Nihon Talc, Ltd. and TALCAN® available from Hayashi Kasei Co., Ltd. Polymer compositions according to the present invention can contain up to about 50% by weight of glass fiber and/or talc.

Other optional non-thermally conductive fillers, colorants, additives, and the like, may be added to embodiments of the present invention. Representative non-thermally conductive fibers which may serve as reinforcing media include synthetic polymeric fibers, silicate fibers, such as aluminum silicate fibers, metal oxide fibers, such as alumina fibers, titania fibers, and magnesia fibers, wollastonite, rock wool fibers, silicon carbide fibers, etc. Representative filler and other non-thermally conductive materials include glass, calcium silicate, silica, clays, such as kaolin, talc, chalk, mica, potassium titanate, and other mineral fillers; colorants, including pigments such as carbon black, titanium dioxide, zinc oxide, iron oxide, cadmium red, iron blue; and other additives such as alumina trihydrate, sodium aluminum carbonate, barium ferrite, etc. Suitable polymeric fibers include fibers formed from high temperature engineering polymers such as, for example, poly(benzothiazole), poly(benzimidazole), polyarylates, poly(benzoxazole), polyaryl ethers and the like, and may include mixtures comprising two or more such fibers. The compositions of this invention may further include additional additives commonly employed in the art, such as thermal stabilizers, ultraviolet light stabilizers, oxidative stabilizers, plasticizers, lubricants, and mold release agents, such as polytetrafluoroethylene (PTFE) powder, and the like. The addition of additives, such as talc and/or titanium dioxide impart a smoother surface to molded articles made from polymeric compositions according to the present invention. The levels of such additives will be determined for the particular use envisioned, with up to about 50 weight %, based on the total weight of the composition, of such additional additives considered to be within the range of ordinary practice in the compounding art.

The invention will be further described by an example. The example is illustrative of the present invention and does not limit the scope of the claimed invention.

### EXAMPLE

The following materials were used in the formulations. The LCP used in the example is XYDAR® SRT-900, a wholly aromatic polyester having a melting point of 350° C. The talc used is VERTAL® 1000 and the glass fiber is CERTAINTEED® 910. The aluminum flakes are Transmet Corporation K-102 1 mm square flakes having a thickness of 25 μm.

### COMPARATIVE EXAMPLE

50% by weight of XYDAR® SRT-900, 25% by weight of CERTAINTEED® 910 glass fibers and 25% by weight of VERTAL® 1000 talc.

### Example 1

45% by weight of XYDAR® SRT-900, 45% by weight of Transmet Corporation K-102 aluminum flakes and 10% by weight of CERTAINTEED® 910 glass fibers.

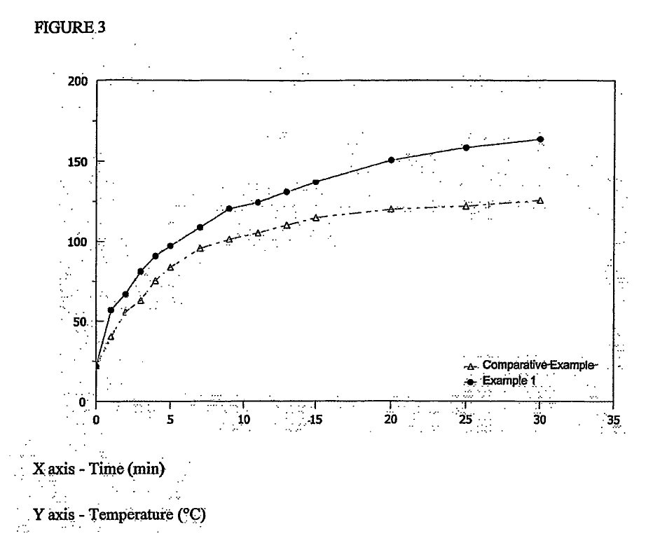

The individual formulations were compounded on a Berstorff twin screw extruder. Subsequently, 4 in×4 in×⅛ in plaques were molded. The thermal conductivity through the thickness was measured and reported in the Table 1 below. The tip of a thermocouple was located at the center of a 4 in×4 in plaque and covered with bread dough. The arrangement plaque/thermocouple/dough was placed in an oven preheated at 250° C. The temperature was recorded as a function of time and the surface of the bread was observed after a 30 minute cycle. Results are depicted in FIG. 3.

Tests were also carried out to verify if browning occurs during cooking. Browning occurs when the temperature at the bread surface reaches 150° C. or more for 5 to 10 minutes. Browning of the bread occurred in Example 1. As shown in FIG. 3, the temperature of Example 1 exceeded 150° C. for about 10 minutes.

TABLE 1

| | Thermal conductivity (W/cm K) |
|---|---|
| Comparative Example | 0.8 |
| Example 1 | 1.5 |

Additional embodiments of the present invention include melt fabricated, injection molded, and extruded articles, such as cookware, including pans, sheets, trays, dishes, and casseroles, made from any of the polymer compositions described herein.

As shown in TABLE 1, the thermal conductivity of Example 1 is about 88% higher than Comparative Example 1. Additional embodiments of the present invention include a method of increasing the thermal conductivity of an article formed from a polymer composition comprising compounding metal particles having a particle size, wherein the particle size of at least 90 weight % of the metal particles is greater than about 200 μm, with a liquid crystalline polymer and forming said article from said polymer composition. Further, in certain embodiments of the present invention, include a method of increasing the thermal conductivity of an article formed from a polymer composition comprising compounding metal particles having an average particle size, wherein the average particle size is greater than about 420 μm, with a liquid crystalline polymer and forming said article from said polymer composition. Furthermore, certain embodiments of the present invention include a use of metal particles, wherein at least 90 weight % of the metal particles have a particle size greater than about 200 μm, as an additive of a liquid crystalline polymer composition to increase the conductivity of the polymer composition. in addition, certain embodiments of the present invention include a use of metal particles having an average particle size, wherein at the average particle size of the metal particles is greater than about 420 μm, as an additive of a liquid crystalline polymer composition to increase the conductivity of the polymer composition.

The embodiments illustrated in the instant disclosure are for illustrative purposes. They should not be construed to limit the scope of the claims. As is clear to one of ordinary skill in this art, the instant disclosure encompasses a wide variety of embodiments not specifically illustrated herein.

1-29. (canceled)

30. A polymer composition comprising a liquid crystalline polymer and metal particles having a particle size, wherein the particle size of at least 90 weight % of the metal particles is greater than about 200 μm.

31. The polymer composition according to claim 30, wherein the particle size of at least 90 weight % of the metal particles is greater than about 400 μm.

32. The polymer composition according to claim 30, wherein the polymer composition comprises from about 20 weight % to about 70 weight % of the metal particles based on the total weight of the polymer composition.

33. The polymer composition according claim 30, wherein the metal particles are selected from the group consisting of aluminum, brass, copper, magnesium, nickel, stainless steel, steel, silver, tin, and zinc particles.

34. The polymer composition according to claim 30, wherein the metal particles are aluminum flakes.

35. The polymer composition according to claim 30, wherein the composition further comprises a non-thermally conductive filler.

36. The polymer compositions according to claim 30, wherein the liquid crystalline polymer is a polyester that is at least partially aromatic.

37. The polymer composition according to claim 30, wherein:
the liquid crystalline polymer is a polyester that is at least partially aromatic, the particle size of at least 90 weight % of the metal particles is greater than about 400 μm, and
the polymer composition comprises from about 20 weight % to about 70 weight % of the metal particles based on the total weight of the polymer composition.

38. The polymer composition according to claim 37, wherein the polyester is formed from the reaction product of at least one dicarboxylic acid selected from the group consisting of terephthalic acid, isophthalic acid, 2,6-naphthalic dicarboxylic acid, 3,6-naphthalic dicarboxylic acid, 1,5-naphthalic dicarboxylic acid, and 2,5-naphthalic dicarboxylic acid; and at least one diol selected from the group consisting of hydroquinone, resorcinol, 4,4′-biphenol, 3,3′-biphenol, 2,4′-biphenol, 2,3′-biphenol, and 3,4′-biphenol.

39. The polymer composition according to claim 37, wherein the polyester is formed from the reaction product of at least one dicarboxylic acid selected from the group consisting of terephthalic acid, isophthalic acid, 2,6-naphthalic dicarboxylic acid, 3,6-naphthalic dicarboxylic acid, 1,5-naphthalic dicarboxylic acid, and 2,5-naphthalic dicarboxylic acid; and at least one diol selected from the group consisting of hydroquinone, resorcinol, 4,4′-biphenol, 3,3′-biphenol, 2,4′-biphenol, 2,3′-biphenol, and 3,4′-biphenol ; and at least one hydroxycarboxylic acid selected from the group consisting of p-hydroxybenzoic acid, m-hydroxybenzoic acid, 2,6-hydroxynaphthalic acid, 3,6-hydroxynaphthalic acid, 1,6 hydroxynaphthalic acid, and 2,5-hydroxynaphthalic acid.

40. The polymer composition according to claim 37, wherein the metal particles are aluminum flakes.

41. The polymer composition according to claim 40, wherein the average length of the aluminum flakes is from about 0.5 mm to about 5 mm, the average width of the aluminum flakes is from about 0.5 mm to about 5 mm, and the average thickness of the aluminum flakes is from about 10 μm to about 100 μm.

42. A melt fabricated article made from the polymer composition according to claim 30.

43. A melt fabricated article made from the polymer composition according to claim 37.

44. A cookware made from the polymer composition according to claim 30.

45. A cookware made from the polymer composition according to claim 37.

46. A polymer composition comprising a liquid crystalline polymer and metal particles having an average particle size, wherein an average particle size of the metal particles is greater than about 420 μm.

47. The polymer composition according to claim 46, wherein the average particle size is greater than about 500 μm.

48. A method of increasing the thermal conductivity of an article formed from a polymer composition, said method comprising compounding metal particles having a particle size, wherein the particle size of at least 90 weight % of the metal particles is greater than about 200 μm with a liquid crystalline polymer and forming said article from said polymer composition.

49. A method of increasing the thermal conductivity of an article formed from a polymer composition comprising compounding metal particles having an average particle size, Wherein the average particle size of the metal particles is greater than about 420 μm.
